(19) United States
(12) Patent Application Publication
(10) Pub. No.: US 2002/0190183 A1
(43) Pub. Date: Dec. 19, 2002

(54) Package fixing device

(76) Inventor: Gyorgy Haas, Somogymeggyes (HU)

Correspondence Address: LERNER AND GREENBERG, P.A., POST OFFICE BOX 2480, HOLLYWOOD, FL, 33022-2480, US

(21) Appl. No.: 10/071,651

(22) Filed: Feb. 8, 2002

Related U.S. Application Data
(63) Continuation of application No. PCT/HU01/00106, filed on Nov. 30, 2001.

(30) Foreign Application Priority Data
Jun. 18, 2001 (HU) 102309

(51) Int. Cl. A47B 97/00; A44B 1/18; B60R 7/00

(52) U.S. Cl. 248/503; 248/205.2; 224/539

(57) ABSTRACT

The package fixing device is supporting instrument made of rigid material that supports things placed in a vehicle bout, and prevents them from moving. It has at least two planar surfaces joined to each other along a line. At least one of the planar surfaces has a normal hooked portion of a hook and loop fastener connected to it.

### CROSS-REFERENCE TO RELATED APPLICATION

This application is a continuation of copending International Application No. PCT/HU01/00106, filed Nov. 30, 2001, which designated the United States.

### BACKGROUND OF THE INVENTION

1. Field of the Invention

The invention relates to package fixing devices. In particular, the invention relates to package fixing devices for supporting and fixing things to carpeted surfaces such as the boot of a vehicle (i.e. the trunk of a car).

2. Description of the Related Art

People use their vehicles to store and carry objects such as luggage, boxes, and bags. For convenience and safety, these objects are usually stored away from the driver and passenger in the boot of the vehicle. However, without anyone to steady them, the objects in the boot of a vehicle move, slide, tip, and overturn during driving. In order to solve this problem, various kinds of boxes and containers have been proposed.

However, these attempted solution typically consume too much space because of their size.

Another possible solution is fixing the objects with rubber belts. The rubber belts connect to points in the vehicle boot and support the objects. The weakness of this solution originates from length of the rubber belts being too limited, and that the belts typically connect to the sidewalls of the boot.

Typically, boots of vehicles are carpeted. While carpets protect the objects being stored, carpets reduce the friction on objects being stored and therefore encourage the movement and sliding of the objects. Moreover, if props or bookend devices are used, they themselves will move and slide around a carpeted trunk.

Janowski et al. (U.S. Pat. No. 5,601,271) teach barriers having conic cross-sections. The barriers are hollow long-shaped bar units made of plastic, having a horizontally constricting lower edge around, supported with small exerted thorns and hooked VELCRO® elements. The edge serves as a sticky foot. Using many barriers, a part of the vehicle's boot can be separated, and if the barriers are out of use, they can be stacked upon each other due to the hollow conic cross-section. The disadvantage of this solution is the costs of production due to its complicated design. Furthermore, the foot-edge must be pushed under the luggage, which is difficult when the luggage is heavy and the bottom of the barrier is covered in VELCRO®. An unsatisfactory alternative is to remove the luggage the lower it onto the preplaced barrier. Owing to the conic shape, the supporting surface always encloses an obtuse angle with the bottom plane under the luggage to be supported, which is not favorable in case of all sorts of luggage.

### SUMMARY OF THE INVENTION

It is accordingly an object of the invention to provide a package fixing device that overcomes the above-mentioned disadvantages of the heretofore-known devices and methods of this general type and secure objects in the boot of a vehicle while still being easily handleable and simply produced simply at low cost.

A further object of the instant application is to provide a package supporting device without a shaped edge that limits the device to objects having a complementary shape. With the foregoing and other objects in view there is provided, in accordance with the invention, a package fixing device for securing objects includes two planar surfaces. The planar surfaces join each other along a line. A hook portion of a hook and loop fastener is connected to at least one of the planar surfaces.

In accordance with a further object of the invention, heavy elements could be included in the planar surface that lies on the floor. For example, the planar surface facing the floor could be made of iron or contain an iron insert. The heavy elements stabilize the device.

Hook and loop fasteners such as those sold under the trademark VELCRO® can be applied to a bookend. The hook and loop fasteners attach to the covering material (i.e. the carpeting or felt) in the vehicle's boot. To attach to the carpeting, merely the hook portion of the hook and loop fastener is required.

By adding the hook portions of a hook and loop fastener to at least one of the planar surfaces (in particular, to the planar surface lying on the ground), objects such as luggage can be secured without needing to lift the object. No lifting is required because two package fixing devices can be used to sandwich the object to be secured. Alternatively, a single package fixing device can be used and the object can be secured against the wall of the boot. In addition, the device reduces the space required.

These two planar surfaces may intersect at different angles. The angle can be an acute, an obtuse, or a right angle. The type of angle can be selected to better complement any special shaped object.

One of the two planar surfaces, which has the hooked part of the Velcro on it will give the sticking, fixative connection with the carpet at the bottom of the car's boot. The other planar surface of the package fixing device will fix the luggage to be supported. This other planar surface may also be covered with a hook and loop fastener such as that sold under the trademark VELCRO®. Furthermore, the object can be made of cloth or have a complementary fastener to allow the device to hold the object.

The device may be may be covered with some kind of soft anti-shock, or fixative cover. The simplest way to fix these coverings onto the rigid shell of the luggage-stay is by adhesive.

The hook portions of the hook and loop fastener can be disposed on the planar surface in parallel rows. Preferably, each planar surface has two parallel rows of hook and loop fastener.

In accordance with a further object of the invention, a hinge can be included to connect the two planar surface. The hinge allows the planar surfaces to be angled relative to each other. The hinge also allows the planar surfaces to be folded over each other to make the device more compact for storage.

In accordance with a further object of the invention, a handle may also be applied which would make holding possible.

In accordance with a further object of the invention, the holding device can be made of wood or plastic.

With the objects of the invention in view, there is also provided a method for securing an object in a boot having a cloth floor. The first step of the method is providing a package fixing device. The package fixing device includes two planar surfaces being joined along a line, and a hook portion of a hook and loop fastener being connected to a first of the planar surfaces. The next step is placing the second of the planar surfaces against an object. The next step is attaching the hook portions on the first of the planar surfaces to the cloth of the boot.

In accordance with a further object of the invention, the method can include providing a second package fixing device. The next step is sandwiching the object by placing a second of the planar surfaces of the second package fixing device against an opposite side of the object. The next step is attaching the first surface of the second package fixing device to the cloth of the boot.

Other features which are considered as characteristic for the invention are set forth in the appended claims.

Although the invention is illustrated and described herein as embodied in a package fixing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective view showing a package fixing device with a fixed angle;

FIG. 2 is a perspective view showing a package fixing device with and adjustable angle;

FIG. 3 is a perspective view showing a block-shaped package fixing device with a cover; and

FIG. 4 is a perspective view showing the package fixing devices fixing a piece of luggage in the open trunk of an automobile.

### DESCRIPTION OF THE PREFERRED EMBODIMENTS

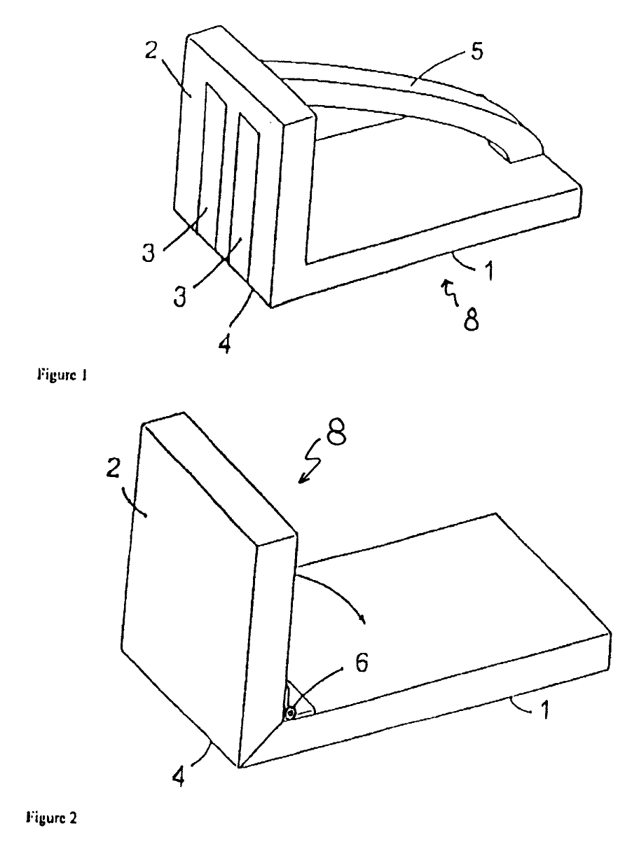

Referring now to the figures of the drawing in detail and first, particularly, to FIG. 1 thereof, there is seen a package fixing device 8 that prevents objects placed in the vehicle boot from moving, rolling, and spilling. The device is made of rigid material. Planar surfaces 1 and 2 join to each other along an edge 4.

The edges of the planar surfaces 1 and 2 can be mitered to form the joint along edge 4. Preferably, the planar surfaces 1 and 2 are made of wood, plastic, metal, or a combination thereof.

At least one of the planar surfaces 1 has the hook portion 3 of a hook and loop fastener such as those sold under the trademark VELCRO® fixed on it. The hook portion 3 releasably attaches to the felt or carpet covering the bottom of the vehicle boot. The other planar surface 2 of the package fixing device supports the luggage 10.

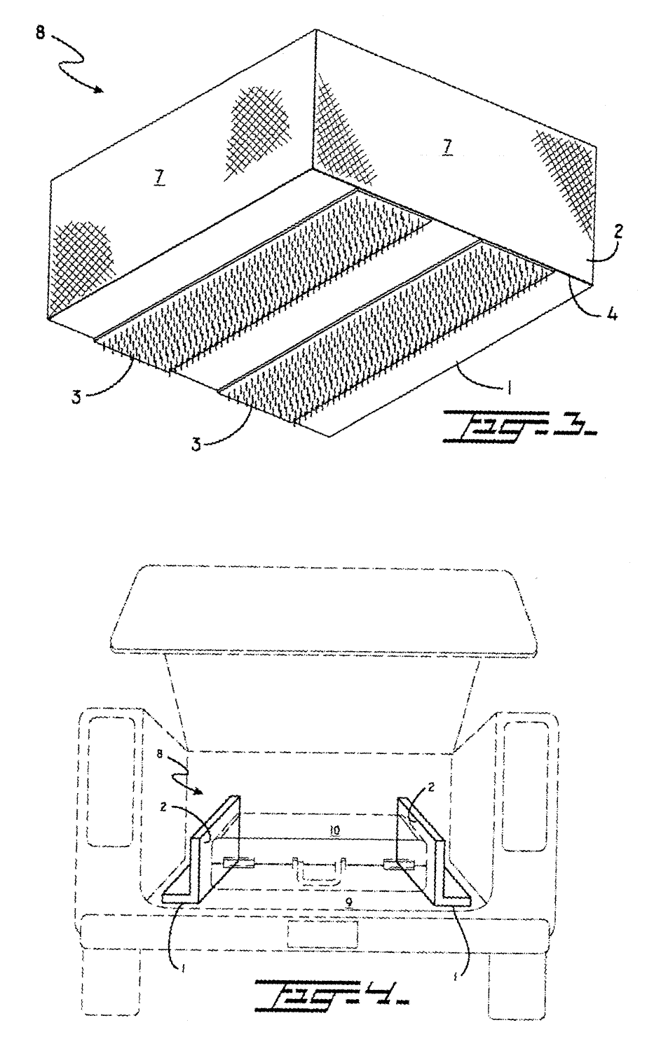

The planar surfaces 1 and 2 he hard or they can be wrapped with a covering 7 as shown in FIG. 3. The covering 7 softens the device 8 and abuts the luggage 10 and prevents the luggage 10 from being damaged. The covering 7 can be a textile, material of synthetic fibers, or a sponge-like material. In addition, rubber or some rubber-like plastic covering can be applied on the planar surface 2.

As seen in FIG. 1, the planar surface 2 also can have the hook portion 3 of a hook and loop fastener attached to it.

Preferably, two parallel lines of the hook portion 3 of a hook and loop fastener should cover the planar surface 1; see FIG. 3. The hook portions 3 can extend to the planar surface 2; see FIG. 1.

In the embodiments shown in the figures, planar surface 1 is perpendicular to planar surface 2. However, the planar surface 1 and the planar surface 2 can be formed with an acute or an obtuse angle to better conform to an objects shape.

As shown in FIG. 2, the angle of planar surface 1 and planar surface 2 can be adjustable. A hinge 6 swivably connects the planar surface 1 and the planar surface 2. The axis of the hinge 6 is parallel to the edge 4. A clamp screw, which is not shown, can temporarily fix the hinge 6 to lock the angle of the planar surface 1 relative to the planar surface 2. In addition, the planar surface 1 can be rotated laid flat on the planar surface 2 by rotating the planar surfaces 1 and 2 about the hinge 6. The collapsed device requires less storage space.

As shown in FIG. 1, the package fixing device includes a handle 5. The handle 5 makes carrying and maneuvering the device easier. This shape of the handle 5 can be changed for aesthetic reasons.

FIG. 3 shows a block-shaped package fixing device 8. The block-shaped fixing device 8 includes a first planar surface 1 and a second planar surface 2. Hook portions 3 of a hook and loop fastener lie in two parallel strips on the planar surface 1. A covering 7 made of cloth overlies the planar surface 2.

FIG. 4 shows two package fixing devices 8 sandwiching an object 10 (i.e. luggage). The planar surface 1 with hook portions 3 fastens the package fixing device 8 to the carpeted floor 9 of the trunk. The planar surface 2 abuts the object 10.

I claim:

1. A package fixing device for securing objects, comprising:
two planar surfaces joining along a line; and
a hook portion of a hook and loop fastener connected to one said planar surfaces.

2. The package fixing device according to claim 1, including a further hook portion of a hook and loop fastener connected to the other of said planar surfaces.

3. The package fixing device according to claim 1, wherein said hook portion is disposed on said one of said planar surfaces in at least two rows.

4. The package fixing device according to claim 1, wherein said planar surfaces are perpendicular to each other.

5. The package fixing device according to claim 1, wherein said planar surfaces are part of a brick.

6. The package fixing device according to claim 1, wherein said planar surfaces form an acute angle.

7. The package fixing device according to claim 1, wherein said planar surfaces form an obtuse angle.

8. The package fixing device according to claim 1, including a hinge rotatably connecting said planar surfaces to each other.

9. The package fixing device according to claim 8, wherein said hinge has an axis and the axis is parallel to the line.

10. The package fixing device according to claim 1, including a covering around the other of said planar surfaces.

11. The package fixing device according to claim 1, including a handle connected to at least one of said planar surfaces.

12. The package fixing device according to claim 8, wherein said planar surfaces are collapsible.

13. The package fixing device according to claim 1, wherein at least one of said planar surfaces is made from a material selected from the group consisting of wood, plastic, and iron.

14. A method for securing an object in a boot having a cloth floor, which comprises:
providing a first package fixing device including two planar surfaces being joined along a line, and a hook portion of a hook and loop fastener being connected to a first of the planar surfaces;
placing the second of the planar surfaces against an object; and
attaching the hook portions on the first of the planar surfaces to the cloth of the boot.

15. The method according to claim 14, which further comprises:
providing a second package fixing device including two planar surfaces being joined along a line and a hook portion of a hook and loop fastener being connected to a first of the planar surfaces;
sandwiching the object by placing a second of the planar surfaces of the second package fixing device against an opposite side of the object; and
attaching the first surface of the second package fixing device to the cloth of the boot.
